(19) United States
(12) Patent Application Publication
(10) Pub. No.: US 2025/0308720 A1
(43) Pub. Date: Oct. 2, 2025

(54) RADIONUCLIDE SOURCE TRANSPORT CONTAINER

(71) Applicant: ARTBIO, Inc., Cambridge, MA (US)

(72) Inventors: Gjermund Fjeld Olsen, Fjerdingby (NO); Tanja Aarvak, Oslo (NO); Judit Tjelmeland Oestby, Kraakstad (NO); Richard David Merriam, Thirsk (GB); Peter Maurice Wilson, Cambridge (GB)

(73) Assignee: ARTBIO, Inc., Cambridge, MA (US)

(21) Appl. No.: 19/083,566

(22) Filed: Mar. 19, 2025

Related U.S. Application Data
(60) Provisional application No. 63/571,513, filed on Mar. 29, 2024.

(51) Int. Cl. G21F 5/015; G21F 5/12

(52) U.S. Cl. CPC G21F 5/015; G21F 5/12

(57) ABSTRACT

Some aspects of the present disclosure are generally related to systems and related methods for transporting radionuclide source materials. In some embodiments, a radionuclide source transport container includes a housing with a radiation shielding disposed therein and where the radiation shielding includes an internal volume disposed therein. A distal portion of a radionuclide source holder may be inserted through an opening of the housing into the internal volume. The radionuclide source holder may be supported in a desired pose within the internal volume. In some embodiments, the system includes a lid configured to be selectively attached to the housing as well as a lid seal configured to form a seal between the lid and the housing and/or a seal configured to form a seal between the radionuclide source holder and the housing to seal the internal volume relative to the surrounding environment.

### RELATED APPLICATIONS

This application claims priority under 35 U.S.C. § 119(e) to U.S. Provisional Patent Application No. 63/571,513, filed Mar. 29, 2024, which is incorporated herein by reference in its entirety for all purposes.

### FIELD

Disclosed embodiments are related to a radionuclide generator source transport container and related methods of use.

### BACKGROUND

Radionuclides such as lead 212 (²¹²Pb) may be used in various applications. For example, ²¹²Pb may be used as a therapeutic in radiation treatments for various health conditions, including various cancers. Typically, radionuclides within a radionuclide generator are transported to sites for use, e.g., hospitals in the case of radiation treatment for cancer, localized radionuclide generator sites, and/or other appropriate sites.

### SUMMARY

In some embodiments, a radionuclide source transport container comprises a housing; a first radiation shielding disposed in the housing; an internal volume formed in the radiation shielding within the housing; an opening formed in the housing, wherein the opening is configured to receive a distal portion of a radionuclide source holder extending through the opening into the internal volume; a lid configured to be selectively attached to the housing to cover the opening; and a lid seal configured to form a seal between the lid and the housing when the lid is attached to the housing.

In some embodiments, a method comprises inserting a distal portion of a radionuclide source holder including a radionuclide source into an internal volume of a first radiation shielding disposed in a housing of a radionuclide source transport container; placing a lid on the housing of the radionuclide source transport container; and locking a lid lock to selectively maintain the lid on the housing.

According to some embodiments, a radionuclide source transport container comprises a housing; first radiation shielding disposed in the housing; an internal volume formed in the radiation shielding within the housing; an opening formed in the housing, wherein the opening is configured to receive a distal portion of a radionuclide source holder extending through the opening into the internal volume; and a housing seal configured to form a seal between radionuclide source holder and the housing to seal the internal volume when the radionuclide source holder is disposed therein.

In some embodiments, a method comprises inserting a distal portion of a radionuclide source holder into an internal volume of a first radiation shielding disposed in a housing of a radionuclide source transport container; placing a lid on the housing of the radionuclide source transport container; and forming a seal between the lid and the housing.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a diagram showing decay pathways between radionuclides, according to some embodiments;

FIG. 2A is a perspective view of a radionuclide source transport container in a closed configuration with a lid lock in a locked configuration, according to some embodiments;

FIG. 2B is a side view of a radionuclide source transport container in a closed configuration with a lid lock in a locked configuration, according to some embodiments;

FIG. 2C is an exploded view of a radionuclide source transport container, according to some embodiments;

FIG. 2D is a cross-sectional view of a radionuclide source transport container in a closed configuration with a lid lock in a locked configuration, according to some embodiments;

FIG. 3A is a perspective view of a radionuclide source transport container in a closed configuration with a lid lock in an unlocked configuration, according to some embodiments;

FIG. 3B is a perspective view of a radionuclide source transport container in an open configuration with a lid lock in an unlocked configuration and a radionuclide source holder, according to some embodiments;

FIG. 3C is a perspective view of a radionuclide source transport container in an open configuration with a lid lock in an unlocked configuration and a radionuclide source holder disposed therein, according to some embodiments;

FIG. 4A is a perspective view of a radionuclide source transport container in an open configuration with a lid lock in an unlocked configuration, according to some embodiments;

FIG. 4B is a perspective view of a portion of a housing of a radionuclide source transport container, according to some embodiments;

FIG. 4C is an exploded view of a portion of a housing of a radionuclide source transport container, according to some embodiments; and

FIG. 5 is a method flow diagram detailing how to use a radionuclide source transport container, according to some embodiments.

### DETAILED DESCRIPTION

Radionuclides may be used for a variety of applications in such fields as medicine, biology, physics, and other industries. Some radionuclides which possess relatively short half-lives may be appropriate for use in various medical applications, such as targeted alpha-particle therapy (TAT). Radionuclides possessing relatively short half-lives may be preferable for some applications so they can be administered to a patient to treat a particular condition (e.g., any of various cancers such as prostate or carcinoid cancers) while limiting the patient's time of exposure to radioactivity. Treatments with radionuclides having shorter half-lives may therefore result in fewer and/or less severe side effects than treatments with radionuclides having longer half-lives.

Conventional radionuclide generators use short-lived radionuclide sources for generating desired radiation which may result in the sources being shipped to a desired site for use. Additionally, even when generators including longer-lived radionuclide sources are used to generate shorter lived progeny radionuclides, such sources may still be shipped to desired sites for use. In either case, shipping of a shielded radionuclide source material and a generator the source material is contained in, which may weight upwards of 50 kgs or more, back and forth is costly, inefficient, and existing transport containers are ill suited for appropriately containing radionuclide sources that may generate gaseous progeny radionuclides during shipping. Accordingly, the Inventors have recognized it is desirable to ship a sub-portion of a radionuclide generator containing a desired radionuclide source including for example, shipping the radionuclide source material while it is held in a radionuclide source holder, as opposed to shipping the entire radionuclide generator. Additionally, conventionally used, short-lived radionuclide generating materials may decay substantially when being shipped and/or stored due to the short half-life of the material. Accordingly, the Inventors have further recognized that using precursor radionuclides having long half-lives may facilitate shipping and/or storage of the precursor radionuclides for long periods without the radionuclides substantively decaying into the undesirable progeny radionuclide. However, some precursor radionuclides may be gaseous, and thus radioactive gas may be emanated from the precursor radionuclides.

In view of the above, the Inventors have recognized that it is desirable to provide both methods and systems that facilitate the safe transport of a radionuclide source disposed within a radionuclide source holder, a radionuclide source carrier, or a radionuclide source container (e.g., not the entire generator). The inventors have accordingly developed a radionuclide source transport container configured to receive the radionuclide source holder and to facilitate the transport thereof, e.g., in the absence of the entire generator. This may improve efficiency regarding shipment of radionuclide materials by shipping the smaller source holder and/or by using longer half-life radionuclide source materials that facilitate fewer shipments. This improved efficiency may also help reduce the number of transports associated with the use of a given radionuclide generator. In instances where a radionuclide source may result in the generation of gaseous progeny radionuclides, the Inventors have also recognized that it may be desirable to form one or more sealed volumes in which to transport the radionuclide source material, thereby facilitating the transport of various types of precursor radionuclide materials.

In some instances, a radionuclide source transport container may include a housing and a first radiation shielding disposed there. The radiation shielding, in some embodiments may define an internal volume configured to receive at least a distal portion of a radionuclide source holder, e.g., containing the radionuclide source material. For example, a cavity may be formed in appropriate shielding material capable of absorbing radiation emitted from a radionuclide source. The internal volume corresponding to the cavity may be sized and shaped to accept a portion of the radionuclide source holder including the radionuclide source disposed therein when the radionuclide source holder is inserted through an opening formed in the housing. Thus, the portion of the radionuclide source holder including the associated radionuclide source may be supported within housing and radiation shielding. In some instances, the portions of the radionuclide source holder may function as seals and/or may be made from one or more radiation shielding materials to help isolate the radionuclide source material within the holder and radionuclide source transport container. Such a construction may facilitate the shipping of the radionuclide source holder and radionuclide source without shipping the entire associated generator.

As noted above, in some instances a radionuclide source may decay to form one or more gaseous progeny radionuclides. Accordingly, in some instances, a radionuclide source transport container may include one or more housing seals configured to seal an internal volume of the system formed within the housing and radiation shielding when a radionuclide source holder is disposed therein. Sealing the internal volume may prevent any radioactive gas generated from a radionuclide source material (e.g., containing precursor radionuclides) from emanating out of the transport container during handling and transport as elaborated on further below. Accordingly, in some embodiments, a seal between the radionuclide source holder and a housing of the radionuclide source transport container may be present, as described above, and may facilitate the sealing of an internal volume where a distal portion of the radionuclide source holder is disposed relative to a surrounding environment. Any of a variety of seals are suitable for use including, for example, an appropriately sized and shaped elastomeric part, an O-ring, a deformable metal seal, and/or any other appropriate type of seal. In some embodiments, the sealed volume and/or the transport container containing the sealed volume may have a low gas permeance, which may be determined using a radiation detector instrument to measure the amount of radiation from radionuclides that escape the sealed volume and/or the transport container. According to some embodiments, the gas permeance of the sealed volume and/or the transport container may be such that the sealed volume and/or transport container exhibits an allowable dose rate, as defined according to the International Atomic Energy Agency (IAEA) Regulations for the Safe Transport of Radioactive Material (2018). Accordingly, the dose rate as measured at any point on the external surface of the sealed volume and/or the transport container may be less than or equal to 10 mSv/h, according to some embodiments.

In some instances, in addition or alternatively to the above, a radionuclide source transport container may include a lid that is configured to be selectively attached to the radionuclide source transport container. The lid may be configured to cover a portion of the housing including an opening through which a radionuclide source holder is inserted into the housing. Thus, the lid may form a closed volume between the lid and housing including a portion of the radionuclide source holder that extends out from the housing of the radionuclide source transport container when the holder is disposed therein. When the lid is selectively attached to the housing, the radionuclide source transport container may be in a closed configuration. Alternatively, when the lid is removed from the housing, the radionuclide source transport container may be in an open configuration. The radionuclide source transport container may further include a lid lock configured to change between a locked configuration and an unlocked configuration to selectively prevent or permit removal of the lid from the radionuclide source transport container. Thus, in some embodiments, the lid lock may be configured to selectively maintain a lid on the housing when the lid lock is in the locked configuration and the lid can be removed when the lid lock is in the unlocked configuration.

Components of the radionuclide source transport container, e.g., a lid, a housing, and/or a lid lock, may be made of any of a variety of suitable materials. For instance, the material of the lid, housing, and/or lid lock, in some embodiments, may be exhibit a suitable combination of dimensions, construction, and material selection to exhibit a desired rigidity, strength, and resistance to radiation during transportation of the radionuclide source holder and associated radionuclide source. In some embodiments, it may further be beneficial for portions of certain components such as the lid, housing, and/or lid lock to have a relatively low density, e.g., to lower the mass of the transport container relative to when the lid, housing, and/or lid lock are made of materials that are of a higher density. Non-limiting examples of materials for the lid, housing, and/or lid lock include aluminum and polyether ether ketone (PEEK). Additionally, appropriate radiation shielding materials may be included in these components as detailed further below to provide appropriate radiation shielding for the transport container. However, it should be understood that any appropriate combination of ceramic, metal, and/or polymeric materials may be used for the various components as the disclosure is not so limited.

It should be understood that any of a variety of suitable materials may be used for a radiation shielding present within a radionuclide source transport container. Non-limiting examples include lead, tungsten, and polymeric composite materials (e.g., composite materials including a polymeric matrix and shielding materials of any appropriate size, shape, and concentration dispersed in the matrix), though other materials are also possible. In some embodiments, the radiation shielding within the radionuclide source transport container is arranged and configured to provide sufficient shielding to facilitate safe handling of the radionuclide source container by a user depending on the type and amount of radionuclide source material that is to be transported. For instance, in some embodiments, the radiation shielding is configured such that the dose rate as measured at any point on the external surface of the transport container is less than or equal to 10 mSv/h. To facilitate such shielding, in some embodiments, the radiation shielding is lead, tungsten, or other appropriate material and may have a thickness that is greater than or equal to 30 mm, greater than or equal to 32 mm, greater than or equal to 34 mm, greater than or equal to 36 mm, or greater than or equal to 38 mm between an exterior of the transport container and an expected position of a radionuclide source disposed within the transport container, e.g., from substantially all locations exterior of the transport container. In some embodiments, the radiation shielding has a thickness that is less than or equal to 40 mm, less than or equal to 38 mm, less than or equal to 36 mm, less than or equal to 34 mm, or less than or equal to 32 mm between an exterior of the transport container and an expected position of a radionuclide source disposed within the transport container, e.g., from substantially all locations exterior of the transport container. Combinations of the foregoing ranges are possible (e.g., greater than or equal to 30 mm and less than or equal to 40 mm). Other ranges are also possible. Note that the amount of radiation shielding (e.g., thickness of the material) may vary based on the material used (e.g., tungsten instead of lead), and may be selected based on the amount of material that may be used to achieve sufficient shielding to facilitate safe user handling of the transport container (e.g., maintain emitted radiation below a desired threshold limit).

Advantageously, the radionuclide source transport containers disclosed herein advantageously facilitate efficient shipment of radionuclide source holders without the need to ship an entire associated radionuclide generator, thereby providing efficient and cost-effective shipping. Moreover, due to the ability of the radionuclide source transport container, in some embodiments, to seal one or more volumes in which a radionuclide source holder is disposed, the transport container may further facilitate the transport of long half-life radionuclides that may decay into gaseous progeny radionuclides and accordingly form radioactive gas. Transporting long half-life radionuclides, as opposed to short half-life radionuclides as in conventional systems, may desirably lessen the number of shipments of the radionuclide source material and facilitate the ability to store the radionuclide source material (e.g., at a point of use of the material) without the material significantly decomposing. Furthermore, radiation shielding present within a housing of a radionuclide source transport container may be configured to minimize the amount of radiation shielding while providing a sufficient amount of shielding. As elaborated on further below, the disclosed container designs may also help to eliminate the use of excessive amounts of shielding in regions where it may not be needed. Thus, the currently disclosed system may also help to decrease the amount of radiation shielding, and thus weight, included in the transport container which may further improve shipping efficiency.

As noted above, the disclosed radionuclide source transport containers may be designed to receive and transport a custom radionuclide source holder. To help facilitate handling and shipping of such a radionuclide source holder and radionuclide source material disposed therein, it may be desirable to maintain a pose (i.e., a combined location and orientation) of the radionuclide source holder within the housing of a radionuclide source transport container. For instance, in some embodiments, the transport container may be configured to maintain a pose of the radionuclide source holder within the container during transport, which may maintain a pose of the radionuclide source material within the radionuclide source holder. Additionally, in some embodiments, the radionuclide source transport containers, as described herein, may be reusable, thereby minimizing waste generation or costs associated with packaging.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

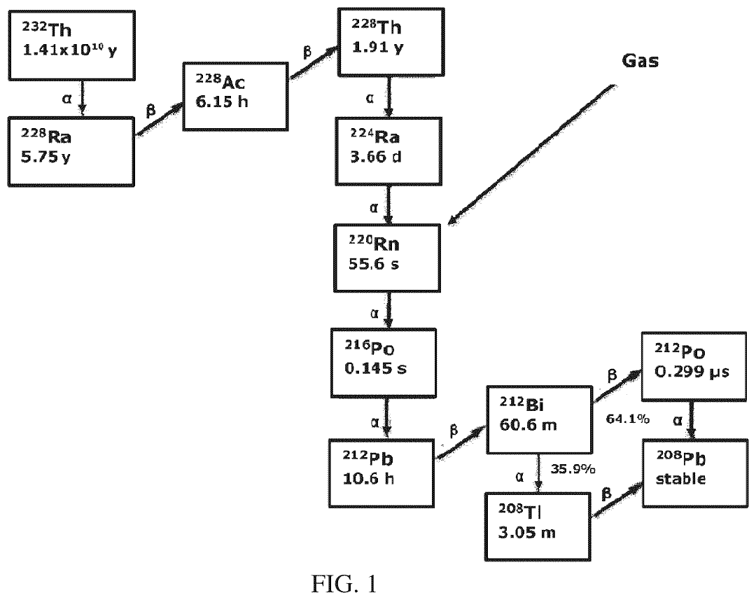

FIG. 1 depicts a diagram of an exemplary thorium series decay chain beginning with thorium 232 (²³²Th). The half-life of each radionuclide in the decay chain is noted in the figure. Note that the radon 220 radionuclide (²²⁰Rn) rapidly decays (e.g., a half-life of 55.6 seconds) into polonium 216 (²¹⁶Po), which further quickly decays (e.g., a half-life of 0.145 seconds) into a lead 212 radionuclide (²¹²Pb). It will further be noted from FIG. 1 that ²²⁰Rn may be a gas at ambient pressure and temperature. Accordingly, it will be appreciated that when a source including a precursor radionuclide to ²²⁰Rn (e.g., ²³²Th, ²²⁸Ra, ²²⁸Ac, ²²⁸Th, or ²²⁴Ra) is exposed to a portion of a container (e.g., an interior surface), the precursor radionuclide may decay into the gaseous ²²⁰Rn. The gaseous ²²⁰Rn may then decay into (e.g., via ²¹⁶Po) ²¹²Pb and may deposit onto the exposed portion of the container as ²¹²Pb. Note that the materials described in FIG. 1 are exemplary, and the radionuclide source transport container described herein may be suitable for use in transporting this type of radionuclide source material within a radionuclide source holder and/or any other suitable radionuclide source material as the disclosure is not so limited. For example, this may include, but is not limited to, dry forms (e.g., not in solution) of radionuclide source materials including isotopes of thorium (e.g., ²³⁴Th, ²³³Th, ²³⁰Th, etc.) as well as any one or more actinides.

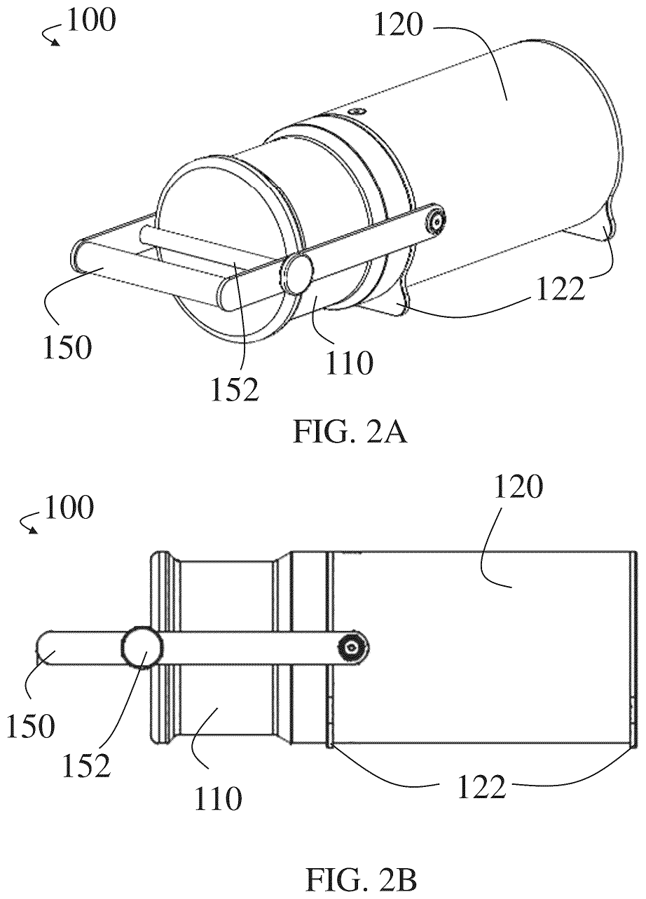

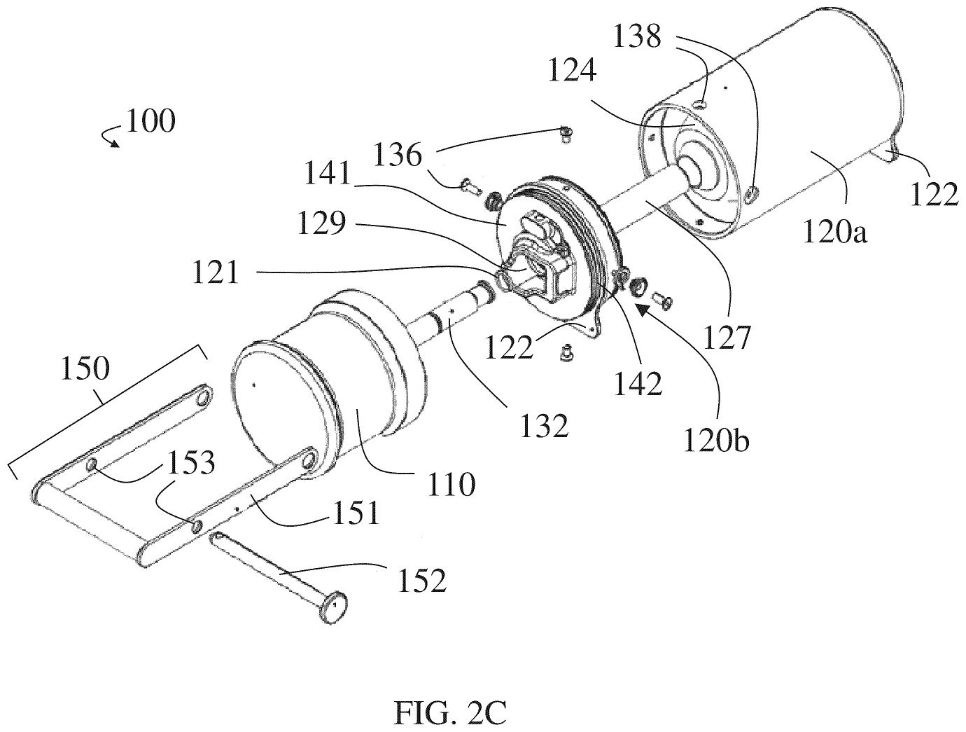

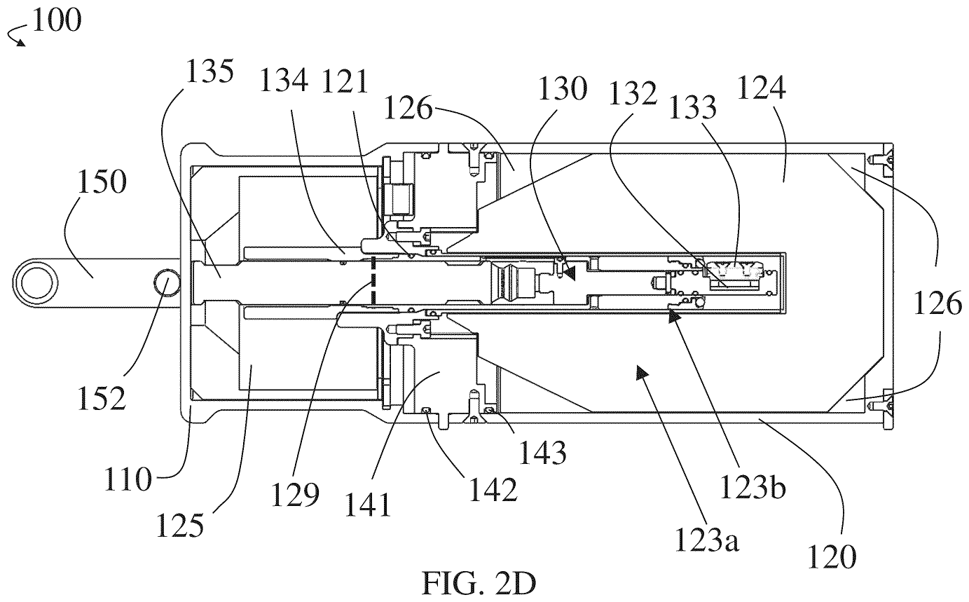

FIGS. 2A-2D show various views of one embodiment of a radionuclide source transport container described herein. In the embodiment shown, the radionuclide source transport container 100 is in a locked configuration. Specifically, a lid 110 is selectively attached to a housing 120 of the radionuclide source transport container 100 with a lid lock 150 in a locked configuration to retain the lid 110 on the housing 120 to isolate an internal volume of the container. These structures are elaborated on further below. In some instances, feet 122 may be formed on or attached to an exterior surface of the housing 120. The feet 122 may be configured to support the radionuclide source transport container 100 in a desired pose relative to an underlying supporting surface the feet 122 and overall radionuclide source transport container 100 are disposed on, which may advantageously facilitate a movement of the lid lock 150, the lid 110, and/or the insertion and/or removal of a radionuclide source holder from the housing 120 of the transport container 100 while the desired pose of the radionuclide source transport container 100 is maintained.

A lid 110 of a radionuclide source transport container 100 may be configured to selectively attach to a housing 120 of the radionuclide source transport container 100. According to some embodiments, the lid 110 may be configured to cover an opening 129 of the housing 120 when selectively attached to the housing 120. In some embodiments, the lid 110 may selectively attach to the housing 120 by any of a variety of suitable attachments. For example, the lid may be selectively attached to the housing by one or more detents, one or more latches, interlocking threads, complementary geometric components, or any other appropriate attachment.

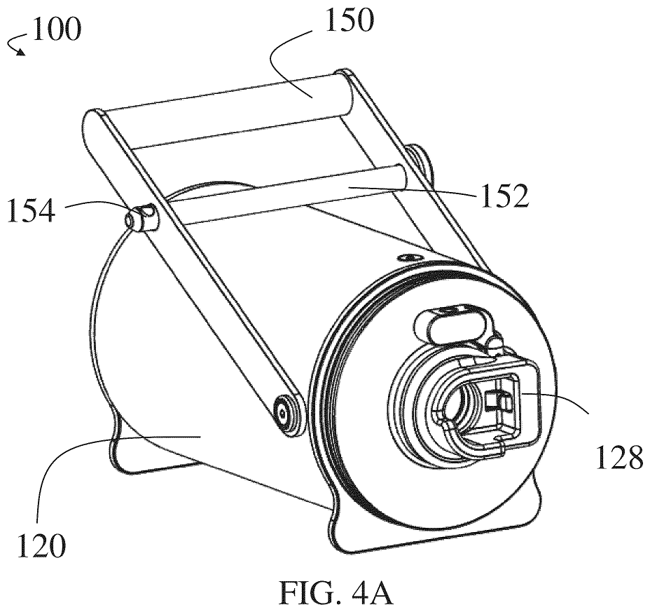

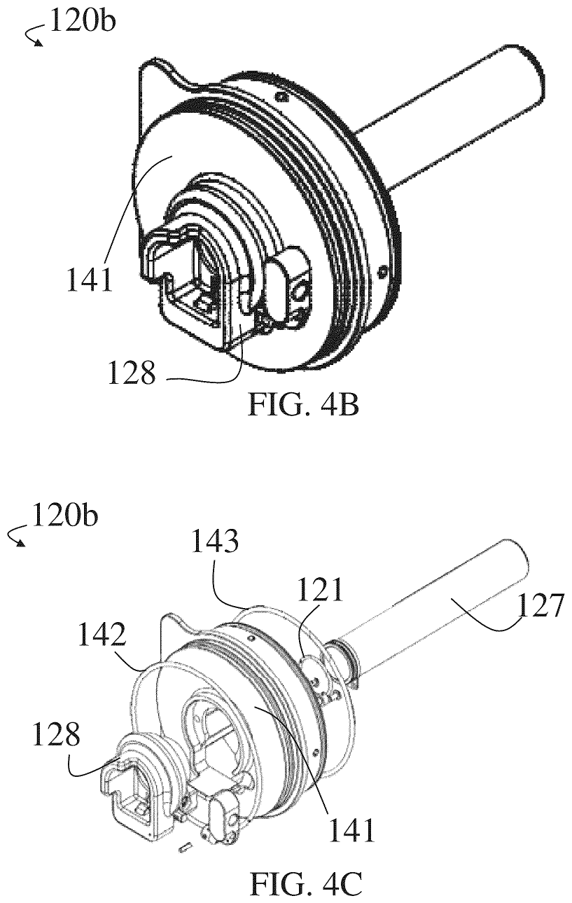

The exploded view in FIG. 2C and the cross-sectional view in FIG. 2D better show the overall construction and various other components of the radionuclide source transport container 100. In some embodiments, the housing 120 includes a first housing portion 120a that is connected to a second housing portion 120b to form the overall housing with an internal volume formed therein. A first radiation shielding 124 may be sized and shaped such that it may be disposed in the internal volume of the housing 120 such that the radiation shielding 124 is disposed between the first housing portion 120a and the second housing portion 120b. The first radiation shielding 124 further defines a second internal volume 123a, such as a cavity, channel, or other suitably sized and shaped volume that is sized and shaped to receive a correspondingly sized and shaped portion of a radionuclide source holder including a radionuclide source disposed therein within the internal volume 123a. The second housing portion 120b can be more clearly seen in FIGS. 4B-4C. The second housing portion 120b may include a supporting ledge 141 on which a source lock 128 may be supported. The source lock 128 is described in more detail below. The supporting ledge 141 may further be configured to align portion 127 of the second housing portion 120b with the internal volume formed in the radiation shielding 124, e.g., when the housing 120 is fully assembled. The supporting ledge 141 may include an opening 129 through which a distal portion of a radionuclide source holder 130 may be inserted into portion 127 of the second housing portion 120b. When fully assembled, the supporting ledge 141 of the second housing portion 120b may be disposed against the first housing portion 120a and/or the radiation shielding 124, where the supporting ledge 141 may be sized and shaped to form a slip fit, or other appropriate type of fit, with a correspondingly sized and shaped opening of the first housing portion 120a in which the second housing portion 120a is inserted when housing 120 is fully assembled.

The second housing portion 120b may include one or more seals 142 and 143, as shown in FIGS. 2D and 4C, such that when the second housing portion 120b is inserted into the first housing portion 120a, the internal volume defined by the first and second housing portions 120a and 120b may be a sealed volume. For example, the one or more seals may be compressed between the first housing portion 120a and the second housing portion 120b (i.e., the supporting ledge 141) to form a sealed volume therebetween. Referring again to FIG. 2C, the second housing portion 120b may additionally include one or more threaded fasteners 136 configured to connect the second housing portion 120b with corresponding threaded inserts and/or holes 138 in the first housing portion 138. Of course, other types of connections are also possible, for example, latches, solder, welds, brazes, adhesives, and/or any other appropriate type of connection. Accordingly, when the radionuclide source transport container is fully assembled, the second portion 120b of the housing 120 is configured to receive a radionuclide source holder inserted through the opening 129 of the housing 120 and into the second internal volume 123b formed within the second portion 120b of the housing which may be located internally from the first radiation shielding 124 disposed in the first internal volume 123a formed between the first housing portion 120a and the second housing portion 120b as elaborated on further below. For instance, as shown in FIG. 2D, when fully assembled, the radionuclide source transport container 100 may include a radionuclide source holder 130 extending into the internal volume 123b formed within the second housing portion.

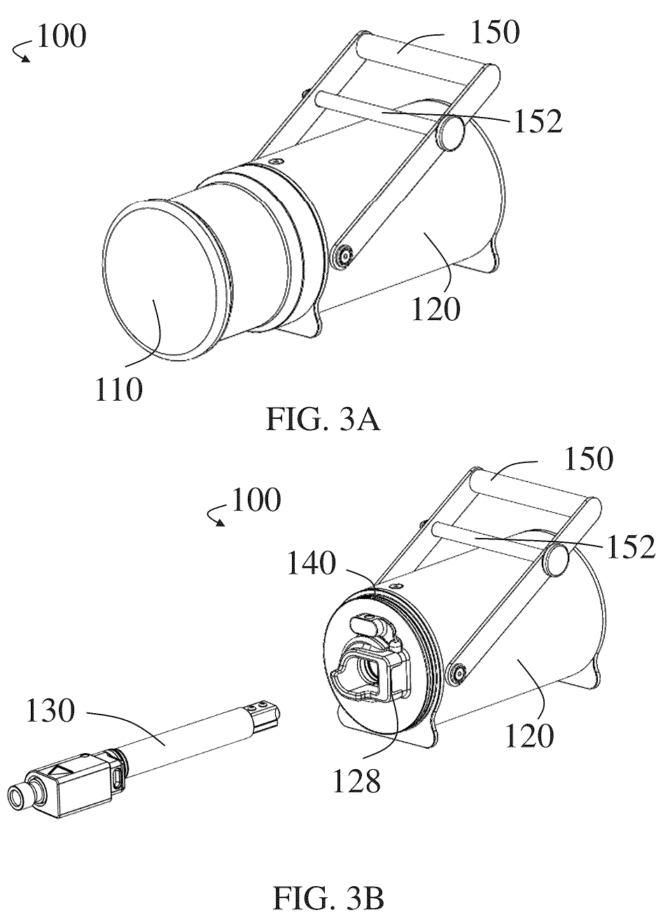

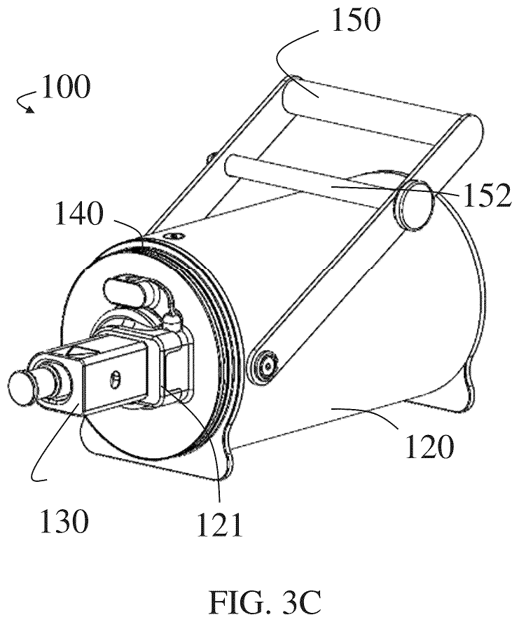

As described above, a distal portion of a radionuclide source holder 130 may be sized and shaped to fit with an internal volume 123b formed by the second housing portion 120b and disposed inward from the radiation shielding 124 when the holder 130 is disposed in the radionuclide source transport container 100. However, the radionuclide source holder 130 may still move axially and/or may rotate within the radiation shielding, which may displace and/or move a radionuclide source 132 from within the radionuclide source holder 130. It may therefore be desirable in some embodiments to maintain a position and/or orientation of the radionuclide source holder 130 within the housing 120 when the radionuclide source holder 130 is inserted into the radionuclide source transport container 100. Accordingly, the housing 120 may include one or more features configured to maintain a desired pose of the radionuclide source holder 130. This may include a source lock 128, as shown in FIGS. 3B-3C, which may be configured to lock an axial and/or rotational position of the radionuclide source holder 130 relative to the housing 120 when the distal portion of the holder 130 is inserted into the housing 120. In the depicted embodiment, a latch may be used as the source lock 128, but in various other embodiments, a source lock 128 may lock the axial and rotational pose of the source holder 130 relative to the housing 120 in any appropriate manner, including using one or more clasps, snaps, detents, fasteners, magnets, threaded engagements, and/or any other appropriate type of lock capable of locking a desired pose of the source holder 130 relative to the housing 120. A source lock 128 of the radionuclide source transport container 100 may be configured to move between a locked and unlocked configuration. When a radionuclide source holder 130 is disposed within the internal volume of the housing 120 of the radionuclide source transport container 100 and the source lock 128 is in the locked configuration, the radionuclide source holder 130 may be prevented from moving axially and rotationally relative to the housing 120. Alternatively, when the source lock is in the unlocked configuration, a radionuclide source holder may move freely into and out of an internal volume of the radionuclide source transport container in an axial direction.

As noted previously, and as further shown in the cross-sectional view of FIG. 2D, radiation shielding 124 may include an internal volume 123b that is sized and shaped to receive a distal end portion to a radionuclide source holder 130 disposed therein. For example, a tube including a closed distal end, or other appropriately sized and shaped portion of the second housing portion 120b is disposed in a cavity formed in the radiation shielding 124 to form the internal volume 123b that the radionuclide source holder 130 may be disposed within. In FIG. 2D, the distal end portion of the radionuclide source holder 130 is inserted through an opening 129 formed in a proximal portion of the second housing portion 120b, which may correspond to the supporting ledge 141. The radionuclide source 130 may extend through the opening 129 into the internal volume 123b formed in the radiation shielding 124 and the second housing portion 120b. Further depicted in the embodiment, a proximal portion of the radionuclide source holder 130 may extend out from the housing 120 such that the proximal portion of the radionuclide source holder 130 is disposed in a cavity defined between the lid 110 (e.g., air gaps 126, as shown in FIG. 2D) and the housing 120 when the radionuclide source holder 130 is disposed in the transport container 100.

The radiation shielding 124 may be configured so as to provide a sufficient amount of shielding from a radionuclide source 132 disposed within a radionuclide source holder 130 when the radionuclide source holder 130 is disposed in a predetermined location within the housing 120, e.g., as shown in FIG. 2D. In some embodiments, the radionuclide source 132 may be sealed and/or held in place on a distal end portion of the radionuclide source holder 130 by a radionuclide source clip 133 engaged with the radionuclide source holder 130 disposed in the container. In the depicted embodiment, the radiation shielding 124 disposed in the housing 120 may be a first radiation shielding. As noted previously, a radiation shielding material may be any of a variety of suitable materials, as described elsewhere wherein. The radiation shielding 124 may be disposed within an internal volume 123a formed between the first housing portion 120a and the second housing portion 120b. Corresponding radiation shielding 125 may also be disposed within the lid 110.

In some embodiments, the radiation shielding 124 may fill the internal volume 123a of the housing 120, regardless of the thickness of the shielding material 124 relative to the radionuclide source. However, such an arrangement may lead to the presence of excess radiation shielding material greater than is needed to shield the radionuclide source 132. As the radiation shielding material is relatively dense compared to other materials of the container 100, this may correspondingly increase the weight of the transport container 100. Accordingly, it may be desirable to avoid the usage of excess shielding material beyond what is needed to properly shield the radionuclide source 132. For example, as shown in FIG. 2D, one or more air gaps 126 may be included within the housing 120 and the lid 110 of the radionuclide source transport container to minimize the weight of the transport container. In the depicted embodiment, the air gaps are disposed between the outer housing portion 120a and the radiation shielding 124 disposed therein. The air gaps may be arranged to provide a thickness of radiation shielding that is between a minimum desired thickness of 5 mm and a maximum desired thickness of 100 mm when measured in a direction oriented towards a predetermined location of the radionuclide source 132 within the internal volume 123b. For example, the corners of the radiation shielding may be chamfered to create the air gaps 126 in some embodiments. These air gaps 126 may advantageously decease the weight of the radionuclide source transport container compared to an embodiment where radiation shielding is present regardless of an overall thickness of the radiation shielding relative to a location of the radionuclide source while still providing a desired amount of shielding.

In view of the above, in some embodiments, a housing 120, a radiation shielding 124, and/or a lid 110 of the radionuclide source transport container 100 may be sized and shaped to receive at least a portion (e.g., a distal portion) of the radionuclide source holder 130. In some embodiments, the radiation shielding 124 may include an internal volume 123b disposed therein (e.g., the elongated tube of second housing portion 120b disposed within a cavity of the radiation shielding 124) that may be sized and shaped to receive the distal end of the radionuclide source holder 130, e.g., to form a slip fit with the distal portion of the radionuclide source holder 130. In some embodiments, the radiation shielding 124 may define an internal volume in which a portion of the housing 120 may be inserted. As better shown in FIG. 4C, an elongated tube 127, or other appropriately sized and shaped portion, of the second housing portion 120b may form the internal volume 123b disposed within a cavity of the radiation shielding 124. The elongated tube 127 of the housing 120 may be configured to receive the distal portion of the radionuclide source holder 130. In some embodiments, the elongated tube 127, or other appropriate portion, of the housing 120 may be sized and shaped to receive the distal end of the radionuclide source holder, e.g., to form a slip fit with the distal portion of the radionuclide source holder. For instance, in FIG. 2D, the radionuclide source holder 130 containing the radionuclide source 132 is depicted such that a distal portion of the source holder 130 extends through the opening 129 of the housing 120 and into the internal volume 123a disposed in the radiation shielding 124 within the housing 120 of the radionuclide source transport container 100. Additionally, as described above, any of a variety of radionuclide sources 132 are suitable for use with the transport container.

In addition to the above, in some embodiments, the lid 110 may additionally contain radiation shielding 125, e.g., similar to the first radiation shielding 124 present in the internal volume of the housing 120 of the transport container 100. In some embodiments, the radiation shielding disposed in the lid 110 may be referred to as second radiation shielding 125. In some embodiments, the second radiation shielding 125 disposed in a lid 110 of the radionuclide source transport container 100 may be similar to the first radiation shielding present in the housing 120 of the radionuclide source transport container 100 in terms of materials, thickness, and/or the shielding properties provided.

As described above, a radionuclide source holder 130 may be inserted into an opening 129 of a lid 110 such that the holder 130 extends into an internal volume 123b disposed within radiation shielding 124 disposed in the housing 120. In some embodiments, one or more portions of the radionuclide source holder 130 may be configured to move between one or more configurations. For example, a portion of the radionuclide source holder 130 may be configured to move between an extended configuration in which the radionuclide source 132 extends out from the radionuclide source holder 130 and a retracted configuration in which the radionuclide source 132 is contained within an interior of the radionuclide source holder 130. For instance, the radionuclide source holder 130 is depicted in the extended configuration with a radionuclide source clip 133 disposed on a distal end portion of the radionuclide source holder 130 containing the radionuclide source 132. Thus, it may be desirable to maintain a desired configuration of the radionuclide source holder 130 when it is disposed within the transport container 100.

In view of the above, in some embodiments, a stop rod 135 may be attached to the lid 110 such that the stop rod is disposed within and extends out from the lid 110. Specifically, when attached to the housing 120 with a radionuclide source holder 130 disposed therein, a distal portion of the stop rod 135 may extend from the lid 110 and into a proximal portion 135 of the radionuclide source holder 130. The stop rod may be appropriately sized and shaped such that a portion of the stop rod 135 inserted into the proximal portion 134 of the radionuclide source holder 130 may contact a piston or other portion of the radionuclide source holder 130 to maintain the radionuclide source holder in a predetermined configuration within the internal volume 123b (e.g., in the extended configuration depicted in FIG. 2D). Thus, the inclusion of such a stop rod 135 may desirably prevent movement and/or rotation of the radionuclide source holder 130 from a desired configuration and/or pose within the transport container 100.

As noted above, in some embodiments, it may be desirable to form one or more seals between the lid 110 and housing 120 and/or between the various portions of the housing (e.g., first and second housing portions 120a and 120b). In the depicted embodiment, a lid seal 142 may be present between the lid 110 and the housing 120 when the lid is attached to the housing to facilitate forming a sealed volume between the lid 110 and housing 120 when the lid 110 is attached to the housing 120 and the transport container is in the closed configuration. A sealed volume may be desirable for preventing escape of any gaseous radionuclides (i.e., radioactive gas) generated by a radionuclide source material within a radionuclide source holder disposed in the transport container 100, as described elsewhere herein. FIG. 4C shows an exploded view of a second portion 120b of housing 120, and further depicts the lid seal 142 that may be present to form a seal between the lid 110 and housing 120. In the shown embodiment, the lid seal 142 is depicted as an O-ring, but any appropriate seal suitable for sealing a volume may also be used, e.g., an elastomer, a metal-metal seal, and/or any other appropriate type of seal. Of course, other appropriate seals between any of the radionuclide source holder 130, the housing 120, and/or the lid 110 may be used as the disclosure is not limited to where or how seals are included in the depicted container to form one or more sealed volumes therein.

To prevent accidental opening, a radionuclide source transport container 100 may further include a lid lock. The lid lock of the radionuclide source transport container may be configured to selectively move between a locked configuration and an unlocked configuration to selectively maintain the lid on the housing. As shown in FIG. 2A, the lid lock 150 is in the locked configuration where it prevents axial motion of the lid relative to the housing. Alternatively, as shown in FIG. 3A, the lid lock 150 may be positioned in the unlocked configuration which allows for axial motion of the lid 110 relative to the housing. Any of a variety of lid locks 150 are possible. Non-limiting examples of potential lid locks may include a latch, interlocking mechanical features, one or more detents, threading, a locking pin, the depicted rotatable arm, and/or any other appropriate type of lid lock capable of selectively permitting and preventing removal of the lid 110 from the container housing 120.

In the exploded view of FIG. 2C, the lid lock 150 in the embodiment shown in FIGS. 2A-2D includes a rotatable arm 151 and a locking pin 152 configured to be selectively attached to the rotatable arm 151, e.g., through through-holes 153 formed on links of the rotatable arm 151 disposed on either side of the lid 110. The position of the removable locking pin 152 on the rotatable arm 151 is selected such that when the locking pin 152 is selectively attached to the rotatable arm 151 of the lid lock 150 in the locked configuration as shown in FIG. 2A. In such an arrangement, the locking pin 152 prevents rotational movement of the rotatable arm 151 from the locked configuration as shown in FIG. 2A to the unlocked configuration as shown in FIG. 3A. Accordingly, the locking pin 152 may prevent axial movement of the lid 110 relative to the housing 120 and prevents the arm 151 from moving to the unlocked configuration due to interference with the lid 110. Thus, the lid lock may maintain the lid 110 of the transport container 100 in a closed configuration such that the internal volume of the transport container 100 may be isolated from the exterior of the transport container 100. Accordingly, in the embodiment of the radionuclide source transport container 100 shown in FIGS. 2A-3C, the locking pin 151 of the lid lock 150 may be removed from the rotatable arm 151 of the lid lock 150 to permit rotational movement of the lid lock 150 from the locked configuration to the unlocked configuration (as shown in the exploded view of FIG. 2C). Of course, while a specific type of lid lock 150 is depicted, other types of locks may also be used as noted above, Additionally, in some embodiment, and as depicted in FIG. 2A-2D, the lid lock 150 may further serve as a handle of the radionuclide source transport container 100 to manipulate the transport container 100, for example, when the lid lock 150 is in the locked configuration.

According to some embodiments, an additional lock may be configured to interface with the lid lock 150. For example, referring to the embodiment shown in FIG. 4A, the additional lock (not depicted) may interface with the locking pin 152 of the rotatable arm 151 of the lid lock 150 at a distal portion 154 of the locking pin 152 that extends past the through holes 153 of the rotatable arm 152 of the lid lock 150, and may prevent removal of the pin 152 from the rotatable arm 151 when the additional lock is in a locked configuration. For example, a locking clip, deformable pin, a keyed lock, electronic combination locks, and/or any other appropriate type of lock capable of maintaining the locking pin in the locked configuration with the arm 151 may be used. Thus, the additional lock may prevent removal of the pin 152 from the rotatable arm of the lid lock 150, thus prevent unintentional removal of the lid 110 from the container 100.

A lid of the radionuclide source transport container may be configured to axially move relative to a housing, thereby changing the transport container between an open configuration and a closed configuration. In some embodiments, to change the radionuclide source transport container from the open configuration to the closed configuration, a lid lock of the transport container may first be moved to an unlocked configuration. For example, as shown in FIG. 2A, lid lock 150 is in a locked configuration while the radionuclide source transport container 100 is in the closed configuration where the lid 110 is selectively attached to the housing 120. In accordance with the embodiment shown in FIG. 2A, the lid lock 150 may be moved to an unlocked configuration, as shown in FIG. 3A, where the lid 110 remains selectively attached to the housing 120. In the depicted embodiment, moving the lid lock to the unlocked configuration may include removing the locking pin 152 from the rotatable arm 151 of the lid lock 150 to facilitate rotation movement of the rotatable arm 151. After removing of the locking pin 152 as shown in the exploded view of FIG. 2C, the rotatable arm 151 may be moved (e.g., rotated) from the locked configuration shown in FIG. 2A to the unlocked configuration shown in FIG. 3A. When the lid lock 150 is in the unlocked configuration, the lid lock 150 is out of an expected path through which the lid 110 may be axially moved relative to the housing 120. Accordingly, once the lid lock 150 is in the unlocked configuration, the lid 110 may then be selectively removed from or attached to the housing 120 by axially sliding the lid 120 relative to the housing 120 to move the lid 110 of the container 100 between an open and closed configuration, though other types of attachments and types of movement of the lid 110 may also be used.

As shown in FIGS. 3A-3C, when a lid 110 is removed from a housing 120 of the radionuclide source transport container 110 and the transport container 110 is in an open configuration, the transport container may be configured to receive a distal portion of a radionuclide source holder 130 as previously described. For instance, radionuclide source holder 130 may be inserted into the opening 129 of the housing 120 of the radionuclide source transport container as shown from FIG. 3B to FIG. 3C. Alternatively, a radionuclide source holder 130 may be removed from the housing 120 of the radionuclide source transport container 100, as shown from FIG. 3C to FIG. 3B. The radionuclide source holder 130 may be configured such that a distal portion extends through opening 129 into an internal volume defined within the radiation shielding 124, as shown in FIG. 2D.

As noted previously, it may be desirable to seal an internal volume of the container 100 in some embodiments. Accordingly, as best seen in FIG. 2C and FIGS. 4A-4C one or more seals may be included to seal a portion of a radionuclide source holder 130 with the housing 120. Specifically, the opening 129 formed in the second portion 120b of the housing 120 may be configured to support a proximal portion of the radionuclide source holder 130 when the radionuclide source holder 130 is inserted into the container 100. Accordingly, in the depicted embodiment, one or more seals 121 may be included to form a seal between the second portion 120b of housing 120 and the radionuclide source holder 130 when the radionuclide source holder 130 is inserted into the internal volume of the housing 120. While the seal 121 is depicted as being disposed on the radionuclide source holder 130 the one or more seals may also be disposed on a corresponding portion of the second portion of the housing as the disclosure is not limited to the type or location of the seal between the radionuclide source holder 130 and the housing 120 to seal the internal volume when the radionuclide source holder 130 is disposed therein.

A seal between one or more portions of the housing 120 of the radionuclide source transport container 100 and the radionuclide source holder 130, as well as any of the other seals disclosed herein, may include any of a variety of seals that are suitable for sealing a volume, for example, an appropriately sized and shaped elastomeric component, an O-ring, a metal-metal seal, and/or any other appropriate type of seal. The inclusion of such a seal and/or a seal between the lid 110 and the housing 120 as previously described above may be desirable in a variety of applications. For example, such seals may be desirable when transporting a radionuclide source disposed in the radionuclide source holder that generates radioactive gas. That is, the one or more seals may help to form one or more sealed internal volumes within the container to prevent radioactive gas from escaping from the internal volume of the container when the radionuclide source holder 130 and the radionuclide source 132 is disposed therein.

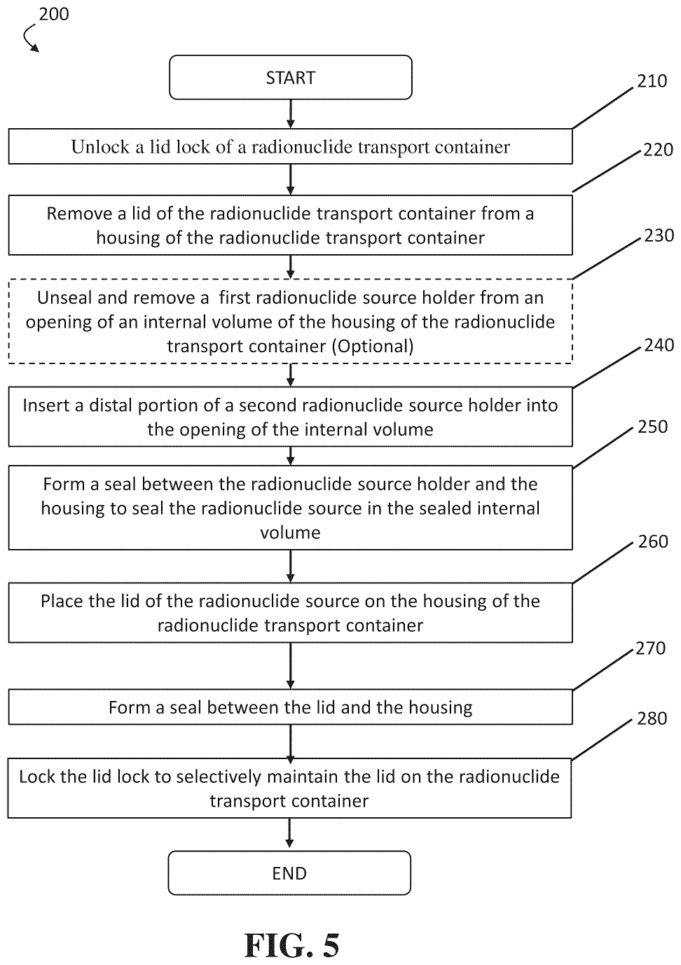

FIG. 5 is an example method flow diagram showing method 500 which details how to use any of the embodiments of a radionuclide source transport container 100 described herein. The method 500 may include unlocking a lid lock of a radionuclide source transport container at 510. As described above in the context of FIGS. 2-3, unlocking the lid lock 150 may include changing a configuration of the lid lock 150 from a locked configuration, as shown in FIG. 2A, to an unlocked configuration, as shown in FIG. 3A. In the depicted embodiment, unlocking the lid lock may include removing a locking pin 152 from a rotatable arm 151 of the lid lock 152, whereafter the rotatable arm may be moved (e.g., rotated) from the locked configuration shown in FIG. 2A to the unlocked configuration shown in FIG. 3A. It will be further appreciated that similar steps or removing the locking pin 152, moving the rotatable arm 151 (e.g., rotating the arm), and reinserting the locking pin 152 may facilitate moving the lid lock from the unlocked configuration to the locked configuration.

Method 500 may also include removing a lid of the radionuclide source transport container from a housing of the radionuclide source transport container 520. In some embodiments, to remove the lid 110, the lid lock 150 may first be unlocked and the lid may be moved axially away from the housing. In some embodiments, the lid may be selectively attached to the housing via latches, one or more detents, threading, a slip fit, and/or any other appropriate type of connection. Optionally, method 500 may include unsealing and removing a first radionuclide source holder from an opening of an internal volume of the housing of the radionuclide source transport container at 530. For instance, in some embodiments, the radionuclide source transport container 100 may contain the first radionuclide source holder 130 such that radionuclide source holder 130 is sealed within the internal volume of the housing 120 of the radionuclide source transport container 100. The first radionuclide source holder 130 present in the transport container 100 may include a spent (e.g., decayed) radionuclide source material 132. In some embodiments, the first radionuclide source holder 130 present in the transport container 100 may include a fresh (e.g., not decayed) radionuclide source material 132. Accordingly, following removal of the lid 110 of the radionuclide source transport container 100, the seal between the radionuclide source holder 130 and the housing 120 of the radionuclide source transport container 100 may be unsealed and the radionuclide source holder 130 may then be removed. Of course, in other embodiments, the first radionuclide source holder may not be contained within the radionuclide source transport container, so method step 530 may not occur.

In instances where there is no first radionuclide source holder and/or after the first radionuclide source holder is removed from the housing of the radionuclide source transport container, the method 500 may include inserting a distal portion of a second radionuclide source holder into the opening of the internal volume at 540. The housing 120 may be configured to receive the distal end portion of the radionuclide source holder 130 and to form a slip fit with the radionuclide source holder 130. The second radionuclide source holder 130 inserted in the transport container 100 may include a spent (e.g., decayed) radionuclide source material 132. Alternatively, in some embodiments, the second radionuclide source holder 130 inserted in the transport container 100 may include a fresh (e.g., not decayed) radionuclide source material 132. Accordingly, once the distal portion of the radionuclide source holder is inserted into the radionuclide source transport container, the method 500 may include forming a seal between the radionuclide source holder and the housing to seal the radionuclide source in the sealed internal volume at 550. As described above, a housing seal may facilitate the forming of a seal between the radionuclide source holder and the housing. According to some embodiments, a source lock may be moved from an unlocked configuration to a locked configuration to maintain a location of the inserted radionuclide source holder. That is, the method may include locking an axial and/or angular position of the radionuclide source holder 130 within the housing 120 using a source lock 128. In some embodiments, the method may further include inserting a stop rod 135 into a proximal portion of the radionuclide source holder 130 to maintain the radionuclide source in a desired location and/or configuration (e.g., an extended configuration).

The method 500 may include placing the lid of the radionuclide source on the housing of the radionuclide transport container at 560. In some embodiments, placing the lid 110 may occur after removing a first radionuclide source holder 130 from an opening 129 of an internal volume of the housing 120 of the radionuclide source transport container 100. In some embodiments, placing the lid 110 may occur following inserting a distal portion of the radionuclide source holder 130 into the radionuclide source transport container 100 and/or forming a seal between the radionuclide source holder 120 and the housing 120 of the radionuclide source transport container 100 and/or after inserting a stop rod 135 into the transport container 100 such that a distal portion of the stop rod 135 is in contact with a proximal portion of the radionuclide source holder 130. Placing the lid on the housing may include selectively attaching the lid to the housing, e.g., via one or more detents, latches, threading, etc. Other mechanisms for selective attachment are described elsewhere herein. In some embodiments, placing the lid may further include extending a proximal portion of the stop rod 135 and/or a proximal portion of the radionuclide source holder 130 into a cavity formed in the lid 110. The method may include placing the lid on the housing so as to form a seal between the lid and the housing at 570.

Following placement of the lid, the method 500 may include locking the lid lock to selectively maintain the lid on the radionuclide transport container 580. In some embodiments, when the lid 110 is placed on the housing 120 and the transport container 100 is in the closed configuration, the lid lock 150 may be moved from an unlocked configuration to a locked configuration, as described above. Once the lid 110 is attached to the housing 120 and the lid lock 150 is in the locked configuration, the transport container may be configured to be transported. The method may further include moving and/or transporting the radionuclide source transport container. In some such embodiments, the radionuclide source transport container 100 may contain a radionuclide source holder 130.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A radionuclide source transport container, comprising:
a housing;
a first radiation shielding disposed in the housing;
an internal volume formed in the first radiation shielding within the housing;
an opening formed in the housing, wherein the opening is configured to receive a distal portion of a radionuclide source holder extending through the opening into the internal volume;
a lid configured to be selectively attached to the housing to cover the opening; and
a lid seal configured to form a seal between the lid and the housing when the lid is attached to the housing.

2. The radionuclide source transport container of claim 1, further comprising a lid lock configured to selectively move between a locked configuration and an unlocked configuration to selectively maintain the lid on the housing.

3. The radionuclide source transport container of claim 1, wherein the lid lock comprises a rotatable arm and a locking pin configured to be selectively attached to the rotatable arm when the rotatable arm is in the locked configuration to prevent axial movement of the lid relative to the housing.

4. The radionuclide source transport container of claim 1, wherein the internal volume is sized and shaped to form a slip fit with the distal portion of the radionuclide source holder.

5. The radionuclide source transport container of claim 1, further comprising a second radiation shielding disposed in the lid and including a cavity configured to receive a proximal portion of the radionuclide source holder.

6. The radionuclide source transport container of claim 5, further comprising a stop rod attached to the lid, wherein the stop rod is configured to be inserted into the proximal portion of the radionuclide source holder to maintain the radionuclide source holder in a predetermined configuration in the internal volume.

7. The radionuclide source transport container of claim 1, further comprising a seal configured to form a seal between the radionuclide source holder and the housing to seal the internal volume when the radionuclide source holder is disposed therein.

8. The radionuclide source transport container of claim 1, further comprising a source lock configured to selectively move between a locked configuration and an unlocked configuration to selectively maintain the radionuclide source holder in a predetermined pose in the internal volume.

9. The radionuclide source transport container of claim 1, further comprising one or more air gaps between the housing and the first radiation shielding.

10. The radionuclide source transport container of claim 1, further comprising the radionuclide source holder including a radionuclide source, wherein the distal portion of the radionuclide source holder is disposed in the internal volume between the lid and the housing.

11. The radionuclide source transport container of claim 10, wherein the radionuclide source of the radionuclide source holder generates a radioactive gas.

12. A method, comprising:
inserting a distal portion of a radionuclide source holder including a radionuclide source into an internal volume of a first radiation shielding disposed in a housing of a radionuclide source transport container;
placing a lid on the housing of the radionuclide source transport container; and
locking a lid lock to selectively maintain the lid on the housing.

13. The method of claim 12, wherein the radionuclide source holder is a second radionuclide source holder, further comprising removing a first radionuclide source holder from the housing of the radionuclide source transport container.

14. The method of claim 12, further comprising locking a pose of the radionuclide source holder in the housing.

15. The method of claim 12, further comprising moving the radionuclide source transport container containing the radionuclide source holder.

16. The method of claim 12, further comprising forming a seal between the radionuclide source holder and the housing.

17. The method of claim 12, further comprising forming a seal between the lid and the housing.

18. The method of claim 17, further comprising generating radioactive gas from the radionuclide source in the radionuclide source holder within a sealed volume of the radionuclide source transport container.

19. The method of claim 12, further comprising inserting a stop rod into a proximal portion of the radionuclide source holder to maintain a configuration of the radionuclide source holder.

20. The method of claim 12, wherein the distal portion of the radionuclide source holder and the internal volume is a slip fit.

21. The method of claim 12, further comprising selectively attaching the lid to the housing.

22. A radionuclide source transport container, comprising:
a housing;
a first radiation shielding disposed in the housing;
an internal volume formed in the first radiation shielding within the housing;
an opening formed in the housing, wherein the opening is configured to receive a distal portion of a radionuclide source holder extending through the opening into the internal volume; and
a housing seal configured to form a seal between the radionuclide source holder and the housing to seal the internal volume when the radionuclide source holder is disposed therein.

23. The radionuclide source transport container of claim 22, further comprising a second radiation shielding disposed in a lid and including a cavity configured to receive a proximal portion of the radionuclide source holder.

24. The radionuclide source transport container of claim 22, further comprising a lid configured to be selectively attached to the housing to cover the opening.

25. The radionuclide source transport container of claim 24, further comprising a lid seal configured to form a sealed between the lid and the housing when the lid is attached to the housing.

26. The radionuclide source transport container of claim 25, further comprising a stop rod attached to the lid, wherein the stop rod is configured to be inserted into a proximal portion of the radionuclide source holder to maintain the radionuclide source holder in a predetermined configuration in the internal volume.

27. The radionuclide source transport container as in claim 24 , further comprising a lid lock configured to selectively move between a locked configuration and an unlocked configuration to selectively maintain the lid on the housing.

28. The radionuclide source transport container of claim 27, wherein the lid lock comprises a rotatable arm and a locking pin configured to be selectively attached to the rotatable arm when the rotatable arm is in the locked configuration to prevent axial movement of the lid relative to the housing.

29. The radionuclide source transport container of claim 22, wherein the internal volume is sized and shaped to form a slip fit with the distal portion of the radionuclide source holder.

30. The radionuclide source transport container of claim 22, further comprising one or more air gaps between the housing and the first radiation shielding.

31. The radionuclide source transport container of claim 22, further comprising the radionuclide source holder including a radionuclide source, wherein the radionuclide source holder is disposed in the internal volume.

32. The radionuclide source transport container of claim 31, wherein the radionuclide source of the radionuclide source holder generates a radioactive gas.

33. A method, comprising:
inserting a distal portion of a radionuclide source holder into an internal volume of a first radiation shielding disposed in a housing of a radionuclide source transport container;
placing a lid on the housing of the radionuclide source transport container; and
forming a seal between the lid and the housing.

34. The method of claim 33, wherein the radionuclide source holder is a second radionuclide source holder, further comprising removing a first radionuclide source holder from the housing of the radionuclide source transport container.

35. The method of claim 33, further comprising locking the lid on the housing.

36. The method of claims 33, further comprising locking a pose of the radionuclide source holder relative to the housing.

37. The method of claim 33, further comprising moving the radionuclide source transport container containing the radionuclide source holder.

38. The method of claim 33, further comprising inserting a stop rod into a proximal portion of the radionuclide source holder to maintain a configuration of the radionuclide source holder.

39. The method of claim 33, further comprising forming a seal between the radionuclide source holder and the housing.

40. The method of claim 33, wherein the distal portion of the radionuclide source holder and the internal volume is a slip fit.

41. The method of claim 39, further comprising selectively attaching the lid to the housing.

42. The method of claim 39, further comprising generating radioactive gas from a radionuclide source in the radionuclide source holder within a sealed volume of the radionuclide source transport container.
